(19) United States
(12) Patent Application Publication
(10) Pub. No.: US 2019/0007954 A1
(43) Pub. Date: Jan. 3, 2019

(54) RESOURCE SCHEDULING METHOD OF WIRELESS COMMUNICATION SYSTEM

(71) Applicants: HON HAI PRECISION INDUSTRY CO., LTD., New Taipei (TW); Czech Technical University in Prague, Prague (CZ)

(72) Inventors: Pavel Mach, Zdar nad Sazavou (CZ); Zdenek Becvar, Prague (CZ)

(21) Appl. No.: 16/022,732

(22) Filed: Jun. 29, 2018

Related U.S. Application Data
(60) Provisional application No. 62/527,203, filed on Jun. 30, 2017.
(60) Provisional application No. 62/609,476, filed on Dec. 22, 2017.

(51) Int. Cl. H04W 72/12; H04W 72/04

(52) U.S. Cl. CPC H04W 72/12; H04W 72/04

(57) ABSTRACT

A resource scheduling method of a wireless communication system is provided. The resource scheduling method includes the following steps. Each of the user equipment (UEs) is classified by a centralized scheduler as a cell-edge UE or a non cell-edge UE. A first scheduling is performed by the centralized scheduler by allocating a first resource for the cell-edge UEs, and a second resource for the non cell-edge UEs. The resource allocation of the first scheduling includes a first region and a second region, and the first region is scheduled earlier than the second region. A ratio of the first resource to the second resource in the first region is greater than the ratio of the first resource to the second resource in the second region.

### CROSS REFERENCE

This application claims the benefit of U.S. Provisional Application Ser. No. 62/527,203, filed on Jun. 30, 2017, and entitled “Scheduling of radio resources for C-RAN” and U.S. Provisional Application Ser. No. 62/609,476, filed on Dec. 22, 2017, and entitled “DYNAMIC SPLIT OF SCHEDULING FUNCTIONALITIES BETWEEN BBU AND RRH”, which are incorporated herein by reference in its entirety.

### TECHNICAL FIELD

The present disclosure generally relates to a resource scheduling methods of wireless communication systems.

### BACKGROUND

The medium access control (MAC) scheduling scheme for cloud radio access network (C-RAN) may utilize a scheduler in the baseband unit (BBU). The fronthaul latency may be the limiting factor to the performance. For example, there might be significant throughput losses due to fronthaul with limited capacity and/or non-zero latency (i.e., non-ideal fronthaul). Another approach utilizes a MAC scheduling split between a BBU and one or more remote radio heads (RRHs). The proposed MAC functional split includes a centralized unit (CU) located in the BBU and distributed unites (DUs) in the RRHs so that the CU is in charge of scheduling and the DUs handle retransmissions by means of hybrid automatic repeat request (HARM). However, the Channel State Information (CSI) aging may degrade the overall network performance.

### SUMMARY

In one aspect of the present disclosure, a resource scheduling method of a wireless communication system is provided. The resource scheduling method includes the following steps. Each of the user equipments (UEs) is classified by a centralized scheduler as a cell-edge UE or a non cell-edge UE. A first scheduling is performed by the centralized scheduler by allocating a first resource for the cell-edge UEs, and a second resource for the non cell-edge UEs. The resource allocation of the first scheduling includes a first region and a second region, and the first region is scheduled earlier than the second region. A ratio of the first resource to the second resource in the first region is greater than the ratio of the first resource to the second resource in the second region.

In another aspect of the present disclosure, a baseband unit (BBU) is provided. The BBU includes a centralized scheduler configured to perform the following instructions. Each of the user equipments (UEs) is classified by a centralized scheduler as a cell-edge UE or a non cell-edge UE. A first scheduling is performed by the centralized scheduler by allocating a first resource for the cell-edge UEs, and a second resource for the non cell-edge UEs. The resource allocation of the first scheduling includes a first region and a second region, and the first region is scheduled earlier than the second region. A ratio of the first resource to the second resource in the first region is greater than the ratio of the first resource to the second resource in the second region.

### BRIEF DESCRIPTION OF THE DRAWINGS

FIG. 1 is a schematic diagram illustrating a wireless communication system, according to an exemplary implementation of the present disclosure.

FIG. 2 is a schematic diagram illustrating a two-level resource scheduling method, according to an exemplary implementation of the present disclosure.

FIG. 3 is a schematic diagram of the overall delay between the Channel State Information (CSI) report from the UE and data reception at the UE of a wireless communication system.

FIG. 4 is a schematic diagram of a resource allocation of the UEs scheduled by the centralized scheduler in the BBU, according to an exemplary implementation of the present disclosure.

FIG. 5 is a schematic diagram of a resource allocation of the UEs scheduled by the centralized scheduler in the BBU, according to another exemplary implementation of the present disclosure.

FIG. 6 is a schematic diagram of a resource allocation of the UEs scheduled by the centralized scheduler in the BBU, according to another exemplary implementation of the present disclosure.

### DETAILED DESCRIPTION

The following description contains specific information pertaining to exemplary embodiments in the present disclosure. The drawings in the present disclosure and their accompanying detailed description are directed to merely exemplary embodiments. However, the present disclosure is not limited to merely these exemplary embodiments. Other variations and embodiments of the present disclosure will occur to those skilled in the art. Unless noted otherwise, like or corresponding elements among the figures may be indicated by like or corresponding reference numerals. Moreover, the drawings and illustrations in the present disclosure are generally not to scale, and are not intended to correspond to actual relative dimensions.

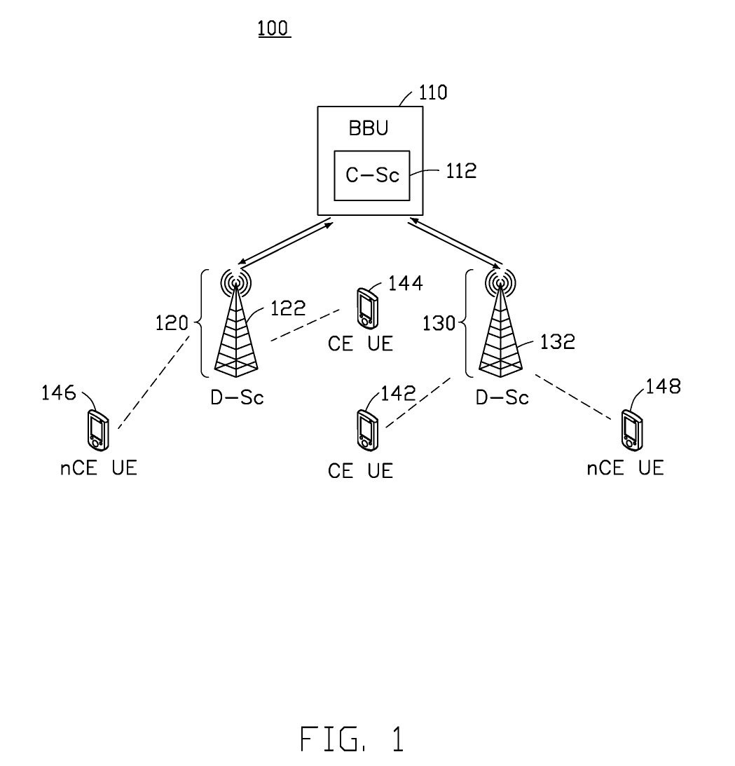

FIG. 1 is a schematic diagram illustrating a wireless communication system 100, according to an exemplary implementation of the present disclosure. The wireless communication system 100 includes a baseband unit (BBU) 110, remote radio heads (RRHs) 120 and 130, and user equipment (UEs) 142, 144, 146 and 148. In this implementation, the BBU 110 is configured to communicate with RRH 120 and RRH 130 through the fronthaul. The RRH 120 is configured to communicate with the UEs 144, and 146. The RRH 130 is configured to communicate with the UEs 142, and 148. In this implementation, the UEs 142 and 144 are the cell-edge (CE) UEs, while the UEs 146 and 148 are the non cell-edge (nCE) UEs. The CE UEs (i.e., CE UE 142 and CE UE 144) suffer from interference imposed by neighboring cells in downlink (DL) transmissions and UEs connected to adjacent cells in uplink (UL) transmissions. For example, CE UE 142 connected to RRH 130 suffers from the interference caused by the RRH 120, or other UEs connected to RRH 120/130, or other UEs connected to in vicinity of RRH 120/130. Similarly, CE UE 144 connected to RRH 120 suffers from the interference caused by the RRH 130, or other UEs connected to RRH 120/130, or other UEs connected to in vicinity of RRH 120/130.

The BBU 110 includes a centralized scheduler (C-Sc) 112. The RRH 120 includes a distributed scheduler (D-Sc) 122. The RRH 130 includes a distributed scheduler (D-Sc) 132. The C-Sc 112 schedules data transmission for CU UEs (e.g., CE UEs 142 and 144). The C-Sc 112 may exploit knowledge on the interference from other cells (RRHs) or other UEs and schedule resources efficiently accordingly. The D-Scs 122 and 132 schedule data transmission for respective nCE UEs (i.e., the D-Sc 122 for the nCE UE 146 and the D-Sc 132 for the nCE UE 148), which are not influenced by interference from the other cells, RRHs or other UEs. In some implementations, the nCE UEs may be influenced by interference from the other cells, but not significantly influenced as the CE UEs. In one implementation, the C-Sc 112 also schedules data transmission for the nCE UEs (i.e., CE UEs 146 and 148).

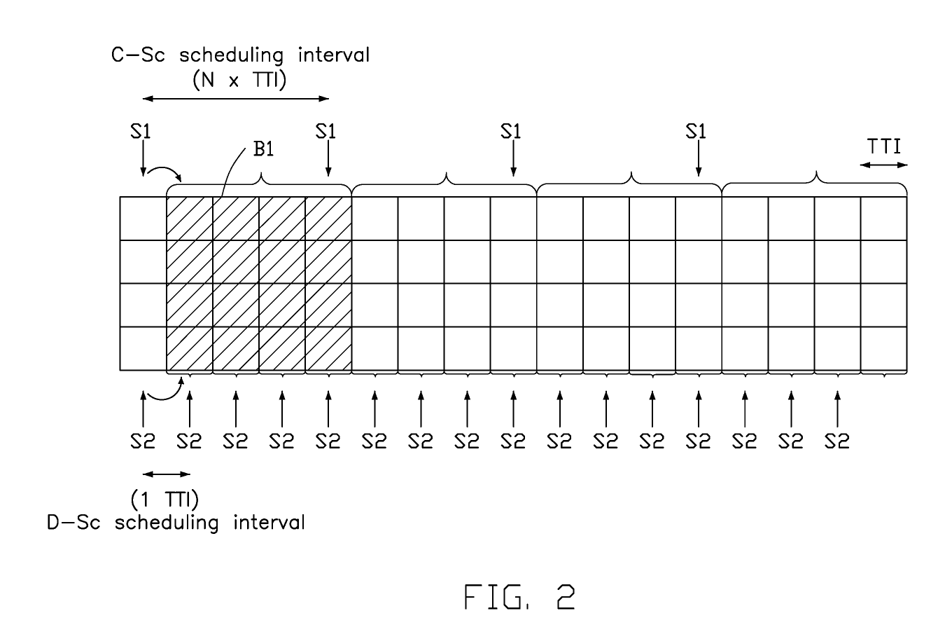

FIG. 2 is a schematic diagram illustrating a two-level resource scheduling method, according to an exemplary implementation of the present disclosure. In this implementation, each of the UEs is classified by the C-Sc as a CE UE or a nCE UE. In one implementation, the UE is classified according to a channel quality, e.g., signal level, reference signal received power (RSRP), reference signal received quality (RSRQ), signal to interference plus noise ratio (SINR), with a predefined threshold (γₜ). For example, if the UE experiences the channel quality below the predefined threshold (e.g., SINR<γₜ), the UE is considered to be a CE UE. On the contrary, if the channel quality is greater than or equal to the predefined threshold (e.g., SINR>γₜ), the UE is considered to be a nCE UE. The predefined threshold (γₜ) is defined to optimize the performance. If γₜ is too low, the number of the UE identified as CE UEs may be small, but some nCE UEs may suffer from strong interference. On the other hand, if γₜ is too high, the number of the UE identified as CE UEs may be high and the amount of available resource blocks may be less since many resource blocks are consumed at many RRHs for the CE UEs in the cooperative multi-point (CoMP) case. The predefined threshold (γₜ) is set with respect to radio channel fluctuation, for example, by a detected mobility state. The status of radio channel may be classified to at least two states: a stable radio channel status (e.g., with a low mobility and/or a high channel coherence time) and an unstable radio channel status (e.g., with a high mobility and/or a low channel coherence time). Additional states of the radio channel fluctuation may be defined for higher granularity of the classification and consequently for a potential improvement of the network performance.

In some implementations, the UE is classified as the CE UE when at least two RRHs coordinate the transmission to the UE, and the UE is classified as the nCE UE when only one RRH performs the transmission to the UE. In some other implementations, the UE is classified according to a fronthaul status of an RRH to which the UE is connected. The classification threshold is set with respect to the fronthaul status, for example, the fronthaul delay, the fronthaul load, available capacity at the fronthaul, etc. The fronthaul status may be classified to at least two states: a high quality fronthaul status (e.g., with a low fronthaul delay and/or a high available capacity and/or a low load of the fronthaul) and a low quality fronthaul status (e.g., with a high fronthaul delay and/or a low available capacity and/or a high fronthaul load). Additional states of the fronthaul status may be defined for higher granularity of the classification.

In one implementation, the UE is classified according to the overall system performance. As an example, the UE is classified as the CE UE and scheduled by the C-Sc, if the UE's classification as the CE UE improves the overall system performance in terms of system capacity (e.g., due to CoMP transmission) or Quality of Service (QoS) requirement. In some implementations, the UE is classified when any combination of the fronthaul status, the radio channel status and the impact on system performance is considered.

In some implementations, the UEs are classified as the CE UE or the nCE UE by the C-Sc dynamically over time. In some implementations, the classification of the UE may be performed periodically, and a period of the classifying step is the same as a scheduling period of the first scheduling. For instance, the classification of the UE is performed at every NxTTI (N consecutive Transmission Time Intervals), where N is a positive integer.

As shown in FIG. 2, the resource scheduling method is performed in two levels with different periodicity, and the scheduling period of the first scheduling performed by the C-Sc is greater than the scheduling period of the second scheduling performed by the D-Sc. The C-Sc performs long-term scheduling S1 by allocating resource blocks (e.g., B1) for both CE UEs and nCE UEs, which is understood as a scheduling decision not only for one TTI, but for N consecutive TTIs (N×TTI). The scheduling period may be adjusted dynamically over time. In the centralized scheduling, a first resource is allocated for the CE UEs, and a second resource is allocated for the nCE UEs. Each part of the first resource is allocated respectively for one of the CE UEs, and each part of the second resource is allocated respectively for one of the nCE UEs. In one implementation, the C-Sc further allocates a third resource for retransmission of the CE UEs.

On the other hands, after the long-term scheduling is performed by the C-Sc, the D-Sc performs the short-term scheduling S2 for the nCE UEs at every TTI (1×TTI). In the D-Sc scheduling, a part of the second resource is allocated respectively for at least one of the nCE UEs. In one implementation, the D-Sc further allocates another part of the second resource for retransmission of the nCE UEs. Thus, the D-Sc may further perform the short-term scheduling for the nCE UEs and the resource allocations (e.g., a part of resource blocks B1) may be adjusted so that the changes in channel quality may be reflected and therefore the performance may be improved. The D-Sc may further tune the long-term scheduling decisions for the nCE UEs tentatively outlined by the C-Sc to improve performance exploiting up to date channel knowledge.

As the nCE UEs do not suffer from the interference imposed by the neighboring RRHs, the scheduling decision for the nCE UEs does not have to be coordinated with neighboring RRHs and it is up to each individual D-Sc to change allocation according to its preference. The D-Sc preforms scheduling for the nCE UEs independently on other RRHs, and the requirement of each underlying nCE UE may be considered by the D-Sc. The D-Sc may schedule resources for the nCE UEs in an arbitrary way. In one implementation, the D-Sc only adjusts the resources scheduled for the nCE UEs by the C-Sc since any change for the CE UEs might lead to an increased interference to the CE UEs. In some implementations, the D-Sc may exploit the resource blocks which are not dedicated to the CE UEs in an arbitrary way, since the interference from other neighboring cell is less significant.

In one implementation, the parameter N of the scheduling period may be adjusted according to a fronthaul status. The fronthaul status may include the delay on the fronthaul. In one implementation, the parameter N of the scheduling period may be adjusted according to a radio channel status. The radio channel status may include a dynamicity of the radio channel (influenced by UEs' mobility, channel variation over time, etc). The parameter N being a high value reduces complexity of the centralized scheduling and lowers signaling overhead between the RRHs and the BBU. On the other hand, if the parameter N being too high, it may lead to a potential degradation of performance (e.g., throughput) as the scheduling does not reflect actual radio conditions (e.g., channel state information aging). In some implementations, the parameter N of the scheduling period may be adjusted when both the fronthaul status and radio channel status are considered.

For any scheduling done in the BBU with periodicity of N consecutive TTIs, a problem of aging of a channel quality information can degrade the overall network performance as the radio resources are assigned to the users according to an outdated knowledge of the channel quality. This is due to the delay between the time when a channel quality report is sent by the UE and the time when the data is transmitted over the radio channel to the UE. The channel quality information can be represented, for example, by a channel state information (CSI).

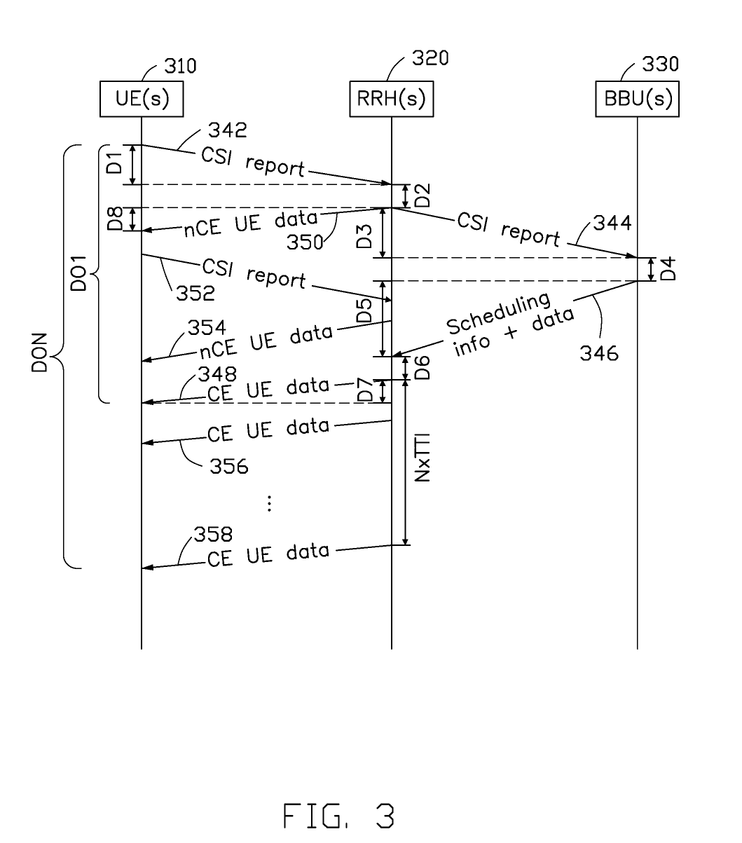

FIG. 3 is a schematic diagram of the overall delay between the Channel State Information (CSI) report from the UE and data reception at the UE of a wireless communication system. The CSI report may include, but not limited to, channel quality indicator (CQI), pre-coding matrix indicator (PMI), and rank indication (RI). In this implementation, the wireless communication system includes user equipment(s), remote radio head(s), and baseband unit(s). In order to describe the time sequence of the overall delay of the wireless communication system, one or more UE(s) are shown in block 310, one or more RRH(s) are shown in block 320, and one or more BBU(s) are shown in block 330. Although a single block of UE(s) 310 or RRH(s) 320 or BBU(s) 330 is shown in FIG. 3, it is understood that each action shown in FIG. 3 may be performed by the respective UE, RRH, or BBU.

In one implementation, when the UE is a nCE UE, the scheduling may be performed or updated by the D-Sc at every TTI in the RRH 320, and the overall delay between the CSI report from the nCE UE and data reception at the nCE UE is less critical. For example, the overall delay of the nCE UE may include (1) a transmission time (i.e., D1) of the CSI report sent from the UE 310 to the RRH 320 (e.g., action 342 or 352); (2) a processing time (i.e., D2) for the processing of the received CSI by the RRH 320 and the scheduling carried out by the D-Sc in the RRH 320; and (3) a transmission time (i.e., D8) of the actual nCE UE data sent from the RRH 320 to the UE 310 (e.g., action 350 or 354).

In one implementation, each delay component may include TTI alignment. For example, each action in FIG. 3 may be performed in the next TTI. The propagation delay is in general negligible as it is in the order of microseconds (μs) (for 1 km UE-RRH distance, the transmission time is roughly 3.3 μs). Furthermore, the transmission time (including TTI alignment and propagation time) can be shortened by cutting down the duration of TTI interval from 1 ms (currently used in LTE(-A) systems) to 0.25 ms (possible option for TTI in 5G networks) or any other duration. Therefore, the overall delay is t_{CSI nCE UE}=D1+D2+D8.

On the other hand, when the UE is a CE UE, the scheduling is performed by the C-Sc in the BBU 330, and the overall delay between the CSI report from the CE UE and data reception at the CE UE is critical and affected by the CSI aging. As shown in FIG. 3, the overall delay of the CE UE may include at least 7 components. The first component is the transmission time (i.e., D1) of the CSI report sent from the UE 310 to the RRH 320 (e.g., action 342). The second component constitutes from the processing time (i.e., D2) of the CSI report by the RRH 320. The third component is the one-way fronthaul delay (in uplink) (i.e., D3), since the RRH 320 has to transmit the CSI report to the BBU 330 (e.g., action 344). In some implementations, for the scheduling purposes, the CSI report from both the CE UEs and the nCE UEs may be sent to the C-Sc in the BBU 330. The fourth component represents the processing time (i.e., D4) required for processing of the received CSI and for the scheduling carried out by the C-Sc in the BBU 330. The fifth component constitutes from the one-way fronthaul delay (in the downlink) (i.e., D5) required to send the centralized scheduling information from the BBU 330 to the RRH 320 (e.g., action 346). In some implementations, the BBU 330 may also send the CE UEs' data to the RRH 320. In some implementations, the one-way fronthaul delay in the downlink (i.e., D5) might be different from the one-way fronthaul delay in the uplink (the third component, i.e., D3). The sixth component represents the processing time (i.e., D6) required for the processing of the centralized scheduling information in the RRH 320. The seventh component is a transmission time (i.e., D7) of the actual CE UEs data transmitted from the RRH 320 to the respective CE UE 310 (i.e., action 348, 356, or 358).

Based on the above, the overall delay for the CE UE scheduled in the first TTI (i.e., D01) is t_{CSI CE UE}=D1+D2+D3+D4+D5+D6+D7. Moreover, since the scheduling for the CE UE is done for N consecutives TTI, further delay is introduced when the transmission of the CE UE is scheduled in the later TTI (e.g., action 356, 358). For example, the overall delay for the CE UE scheduled in the last (N-th) TTI (i.e., DON) may be t_{CSI CE UE}=D1+D2+D3+D4+D5+D6+D7+N×TTI.

As mentioned before, the parameter N of the scheduling period may be adjusted according to a fronthaul status (e.g., fronthaul delay) or a radio channel status (e.g., channel coherence time) to save the signaling resources or to alleviate the processing load at the BBU. For instance, if the fronthaul delay is negligible, a higher value of N may be selected. Alternatively, a lower value of N may be selected if the fronthaul delay is higher than a predetermined threshold. However, the resource allocation of the CE UEs is performed at every N×TTI, which means that the CSI might be outdated when data is physically transmitted from the RRH to the CE UE. For example, the probability of a change in the channel condition may increase as the CSI reported to the BBU is aging. As a consequence, the probability of errors occurring in transmission to the CE UEs may also increase with time, and the performance of the centralized scheduling may be degraded.

As such, in the present disclosure, a resource scheduling method is provided to schedule more resources for the CE UEs at earlier times (i.e., the first several TTIs after the centralized scheduling decision is done or after the scheduling decision is delivered to the RRHs) in the centralized scheduling. Since the scheduling for the nCE UEs is performed or updated at every TTI, the CSI aging problem is less critical for the nCE UEs, and the resource allocation for the nCE UEs may be scheduled in the later TTIs.

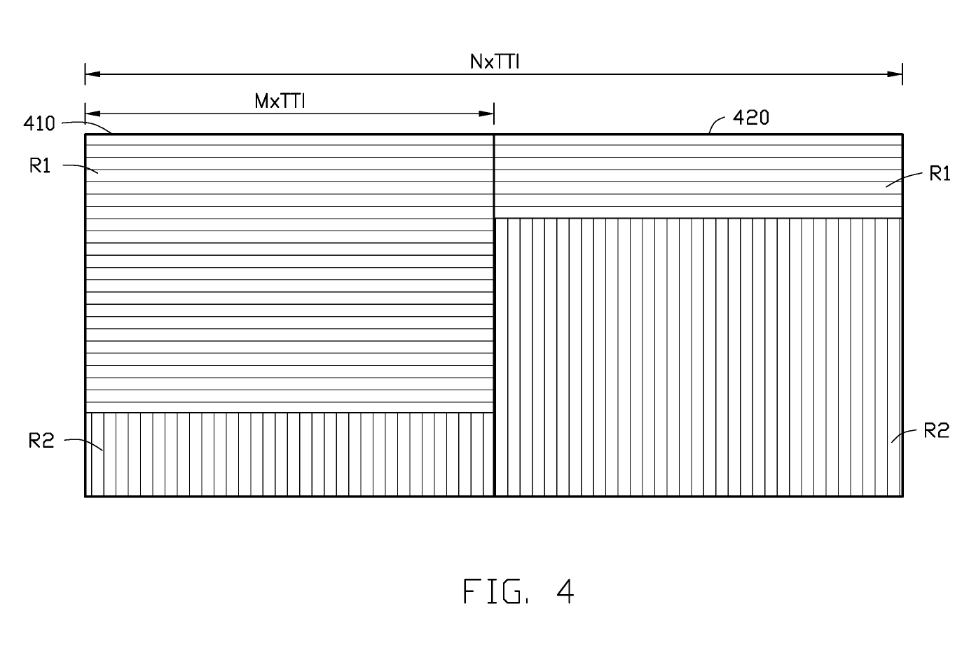

FIG. 4 is a schematic diagram of a resource allocation of UEs scheduled by the C-Sc in the BBU, according to an exemplary implementation of the present disclosure, where a first resource R1 is allocated for the CE UEs, and a second resource R2 is allocated for the nCE UEs. A part of the first resource R1 is allocated respectively for one of the CE UEs, and a part of the second resource R2 is allocated respectively for one of the nCE UEs. It is noted that the size, position, timing and other features of the first resource R1 and the second resource R2 are not limited, and the size, position, timing and other features of the resource for each UE (CE UE, or nCE UE) are not limited.

As shown in FIG. 4, the resource allocation of the centralized scheduling includes a first region 410 and a second region 420, and the first region 410 is scheduled at an earlier time slot than the second region 420. In one implementation, the time duration of the first region 410 and the second region 420 may include one or more TTIs. In some implementations, the size of the first region 410 may be different from the size of the second region 420. In some implementations, the time duration of the first region 410 may be different from the time duration of the second region 420. For instance, the time duration of the first region 410 may include more (or less) TTIs than the time duration the second region 420.

In this implementation, a ratio of the first resource (i.e., R1) to the second resource (i.e., R2) in the first region 410 is greater than a ratio of the first resource (i.e., R1) to the second resource (i.e., R2) in the second region 420. In one implementation, the ratio of the first resource to the second resource is calculated according to the size of the resource blocks of the first resource to the size of the resource blocks of the second resource. For example, the ratio of the first resource to the second resource (i.e., R1/R2) in the first region 410 is 3, which is greater than the ratio of the first resource to the second resource (i.e., R1/R2) in the second region 420 (e.g., ⅓).

In one implementation, the amount of resources for the CE UE/nCE UE may vary in each TTI. In some implementations, the total amount of resources allocated for the CE UEs in the centralized scheduling (N×TTI) may be different from the overall amount of resources allocated for the nCE UEs. Therefore, it is possible that there are more resources allocated for the nCE UEs than the resources for the CE UEs in the first region as long as the ratio of the first resource to the second resource in the first region is greater than the ratio of the first resource to the second resource in the second region (e.g., 1.1>0.9, or 0.8>0.6, 2>1). In some implementations, more resources may be allocated to the nCE UEs in a later time since the D-Sc in the RRH is able to dynamically adapt to the scheduling for the nCE UEs. In some implementations, the proportion between the resources for the CE UEs and nCE UEs in each TTI may consider one or more common QoS requirements, such as, packet delay or priority.

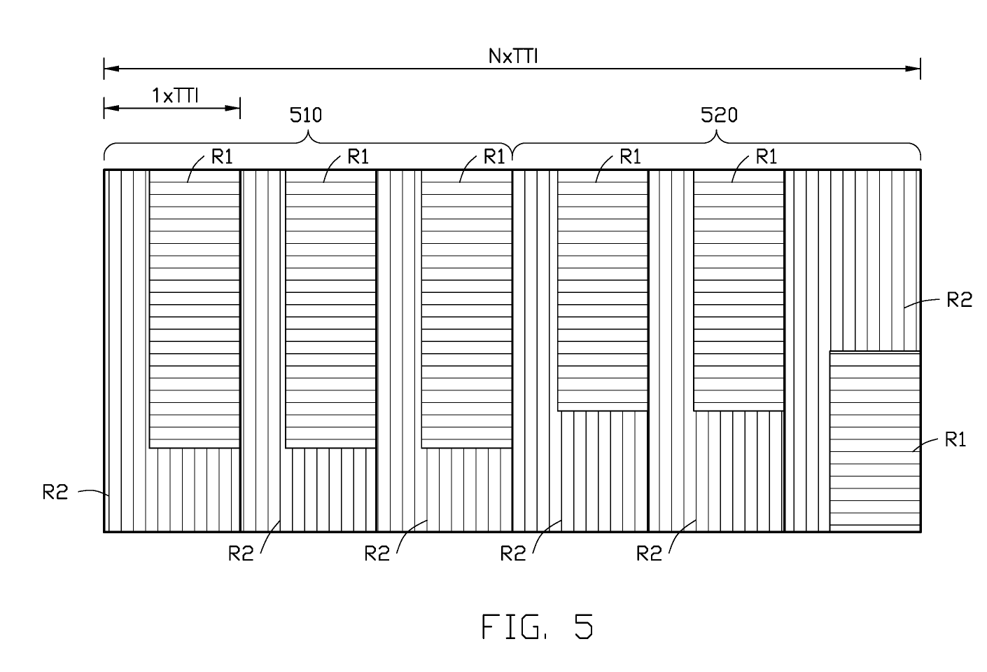

FIG. 5 is a schematic diagram of a resource allocation of the UEs scheduled by the C-Sc in the BBU, according to another exemplary implementation of the present disclosure. As shown in FIG. 5, the resource allocation of the centralized scheduling includes a first region 510 and a second region 520, and the first region 510 is scheduled at an earlier time slot than the second region 520. In this implementation, with N=6, the time duration of the first region 510 includes 3 TTIs, and the time duration of the second region 520 also includes 3 TTIs. In some other implementations, the size of the first region 510 may be different from the size of the second region 520. In some other implementations, the time duration of the first region 510 may be different from the time duration of the second region 520.

In one implementation, the time duration of the first region 510 or the second region 520 is determined by the C-Sc in response to a radio channel status. The radio channel status may include a channel quality, e.g., signal level, reference signal received power (RSRP), reference signal received quality (RSRQ), signal to interference plus noise ratio (SINR), with a predefined threshold (γₜ). The status of radio channel may be classified to at least two states: a stable radio channel status (e.g., with a low mobility and/or a high channel coherence time) and an unstable radio channel status (e.g., with a high mobility and/or a low channel coherence time). Additional states of the radio channel fluctuation may be defined for higher granularity of the classification and consequently for potential improvement of the network performance. For example, if the UE experiences a channel quality below the predefined threshold (e.g., SINR<γₜ) or the radio channel status is identified as unstable, the time duration of the first region is set shorter and the time duration of the second region is set longer and there are more resources allocated for the CE UE(s) in the first region. On the contrary, if the channel quality is greater than or equal to the predefined threshold (i.e., SINR>γₜ) or the radio channel status is identified as stable, the time duration of the first region may be set longer and the time duration of the second region may be set shorter.

In another implementation, the time duration of the first region or the second region is determined by the C-Sc in response to a fronthaul status. The fronthaul status may include, but not limited to, the fronthaul delay, the fronthaul load, available capacity at the fronthaul, etc. The fronthaul status may be classified to at least two states: a high quality fronthaul status (i.e., with a low fronthaul delay and/or a high available capacity and/or a low load of the fronthaul) and a low quality fronthaul status (i.e., a high fronthaul delay and/or a low available capacity and/or a high fronthaul load). Additional states of the fronthaul status may be defined for higher granularity of the classification. For example, if the fronthaul delay is greater than a predetermined threshold or the fronthaul status is identified as low quality, the time duration of the first region is set shorter and the time duration of the second region is set longer, so that there are more resources allocated for the CE UE(s) in the earlier time. On the contrary, if the fronthaul delay is not greater than the predetermined threshold or the fronthaul status is identified as high quality, the time duration of the first region may be set longer and the time duration of the second region may be set shorter.

In yet another implementation, the time duration of the first region or the second region is determined by the C-Sc in response to one or more QoS requirements of the CE UEs, such as, packet delay, priority, packet loss rate, or buffer status. For example, if the QoS requirements of the CE UEs are high, the time duration of the first region is set shorter and the time duration of the second region is set longer, so that there are more resources allocated for the CE UE(s) in the earlier time. On the contrary, if the QoS requirements of the nCE UEs are low, the time duration of the first region may be set longer and the time duration of the second region may be set shorter.

The ratio of the first resource R1 to the second resource R2 in the first region 510 is greater than the ratio of the first resource R1 to the second resource R2 in the second region 520. That is, more resources allocation for the CE UE are scheduled in the earlier TTIs. Therefore, the overall delay for the CE UE may be reduced, and the CSI aging problem may be alleviated. For example, the overall delay for the CE UE scheduled in the k-th TTI is t_{CSI CE UE}=D1+D2+D3+D4+D5+D6+D7+k×TTI. Since there are more resources for the CE UE scheduled in the first region 510 (with k being smaller than N), the delay of the majority of the CE UEs will be reduced. When the time duration of the first region 510 is set shorter, which means that resources for the CE UE scheduled in the earlier TTIs, the delay is reduced.

On the other hand, when the ratio (R1/R2) in the first region 510 is set higher, which means that more resources for the CE UE scheduled in the first region 510, and the delay is further reduced. In one implementation, the ratio of the first resource to the second resource of the first region or the second region is determined by the C-Sc in response to a radio channel status. In another implementation, the ratio of the first resource to the second resource of the first region or the second region is determined by the C-Sc in response to a fronthaul status. In yet another implementation, the ratio of the first resource to the second resource of the first region or the second region is determined by the C-Sc in response to a QoS requirement, such as, packet delay or priority or buffer status.

For example, when the radio channel status is unstable, or the fronthaul status is non-ideal, or the QoS requirement is not met, the BBU may set a higher ratio (R1/R2) for the earlier TTIs (i.e., the first region 510), or set a lower ratio (R1/R2) for the later TTIs (i.e., the second region 520). As a result, more resources for the CE UE are scheduled in the earlier TTIs and the CSI aging problem may be further mitigated. In the most extreme case, the whole region 510 (first several TTIs) may be dedicated solely to the CE UEs while the nCE UEs are not scheduled in the region 510, and therefore the ratio (R1/R2) in the first region 10 is nfinite (00). In some other implementations, the whole region 520 (last several TTIs) may be dedicated solely to the nCE UEs, and the ratio (R1/R2) in the second region 520 is zero (0).

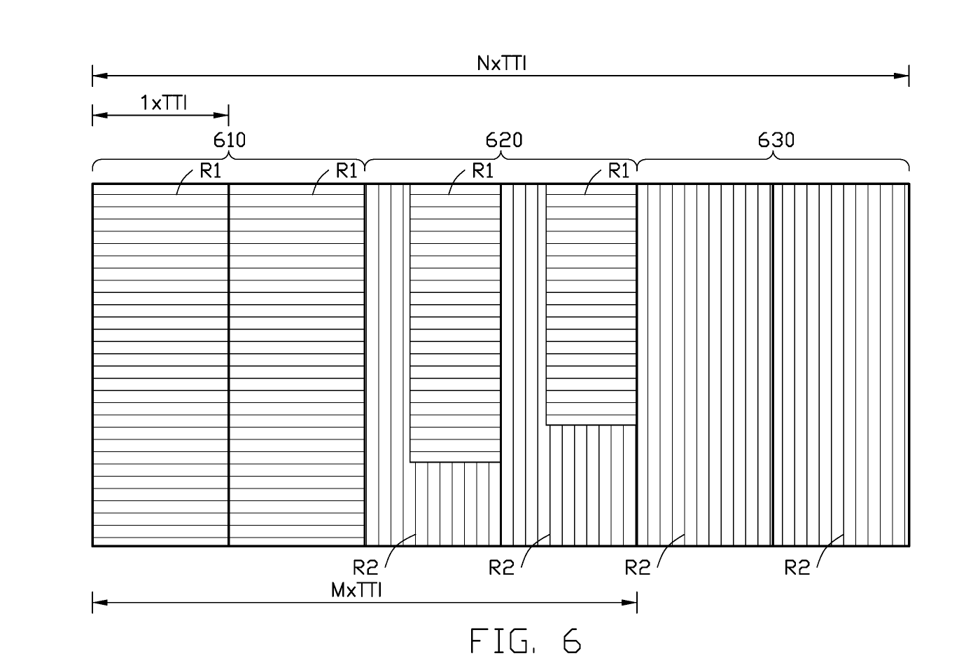

FIG. 6 is a schematic diagram of a resource allocation of the UEs scheduled by the C-Sc in the BBU, according to another exemplary implementation of the present disclosure. As shown in FIG. 6, the resource allocation of the centralized scheduling includes a first region 610, a second region 620, and a third region 630. In this implementation, the first region 610 is scheduled at an earlier time slot than the second region 620 and the third region 630, and the second region 620 is scheduled earlier than the third region 630. With N=6, the first region 610 (the first 2 TTIs) are dedicated solely for the CE UEs, the second region 620 (the middle 2 TTIs) are shared by the CE UEs and nCE UEs, and the third region 630 the last 2 TTIs) are left solely for the nCE UEs. In some implementations, the size of one of the three regions may be different from the size of the others. In some implementations, the time duration of one of the three regions may be different from the time duration of the others. In some other implementations, the number of the regions of the centralized scheduling performed by the C-Sc is not limited as long as the ratio of the first resource to the second resource in the earlier region is greater than the ratio of the first resource to the second resource in the latter region.

In this implementation, the first resource R1 allocated for the CE UEs are in the first region 610 and the second region 620 (in the first M=4 TTIs). Thus, the fronthaul delay is related only to the first M×TTIs instead of all N×TTIs. The overall delay for the CE UE in the last (M-th) TTI is t_{CSI CE UE}=D1+D2+D3+D4+D5+D6+D7+M×TTI, where M (=4) is the time duration (TTIs) of the first region 610 and the second duration 620. As a result, the overall delay for the CE UE may be reduced, and the influence of CSI aging problem may be alleviated.

Furthermore, a higher value of the parameter N (the first or centralized scheduling period) may be used, while all the fronthaul status, radio channel status and QoS requirement should cover budget time of M only. Therefore, the proposed resource allocation method increases flexibility in selection of the value of parameter N and allows to increase the value of N if needed. In this case, the RRH is able to dynamically adapt to varying channel conditions to overcome channel fluctuation.

As described above, several resource scheduling methods are provided. According to the resource scheduling method, a first scheduling is performed by the C-Sc for both CE UEs and nCE UEs, and a second scheduling is performed by a D-Sc for the nCE UEs. When the scheduler is in BBU only, the fronthaul latency may limit the system performance. When the scheduler is in RRH only, the complexity and power consumption of the scheduler may be high. Therefore, the resource scheduling method provided in this disclosure improves the performance while the complexity and power consumption of the scheduler are low.

The implementations shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A resource scheduling method of a wireless communication system, comprising:
classifying, by a centralized scheduler, each of a plurality of user equipments (UEs) as a cell-edge UE or a non cell-edge UE; and
performing, by the centralized scheduler, a first scheduling by allocating a first resource for the cell-edge UEs, a second resource for the non cell-edge UEs;
wherein a resource allocation of the first scheduling includes a first region and a second region, the first region is scheduled earlier than the second region, a ratio of the first resource to the second resource in the first region is greater than the ratio of the first resource to the second resource in the second region.

2. The resource scheduling method of claim 1, further comprising:
performing, by a distributed scheduler, a second scheduling by allocating a part of the second resource for at least one of the non cell-edge UEs.

3. The resource scheduling method of claim 1, wherein each UE is classified as the cell-edge UE or the non cell-edge UE in response to a fronthaul status of an RRH to which the UE is connected.

4. The resource scheduling method of claim 1, wherein each UE is classified as the cell-edge UE or the non cell-edge UE in response to an overall network performance.

5. The resource scheduling method of claim 2, wherein a scheduling period of the first scheduling is greater than the scheduling period of the second scheduling.

6. The resource scheduling method of claim 1, wherein the UEs are classified by the centralized scheduler periodically, and a period of the classifying step is the same as a scheduling period of the first scheduling.

7. The resource scheduling method of claim 1, wherein a time duration of the first region is determined, by the centralized scheduler, in response to a Quality of Service requirement.

8. The resource scheduling method of claim 1, wherein a time duration of the first region is determined, by the centralized scheduler in response to a fronthaul status.

9. The resource scheduling method of claim 1, wherein a time duration of the first region is determined, by the centralized scheduler in response to a radio channel status.

10. The resource scheduling method of claim 1, wherein the ratio of the first resource to the second resource is determined, by the centralized scheduler, in response to a Quality of Service requirement.

11. The resource scheduling method of claim 1, wherein the ratio of the first resource to the second resource is determined, by the centralized scheduler, in response to a fronthaul status.

12. The resource scheduling method of claim 1, wherein the ratio of the first resource to the second resource is determined, by the centralized scheduler, in response to a radio channel status.

13. The resource scheduling method of claim 1, wherein the resource allocation of the first scheduling further includes a third region scheduled later than the first region and the second region, and the third region is scheduled solely for the non cell-edge UEs, and a time duration of the sum of the first region and the second region is determined, by the centralized scheduler, in response to a Quality of Service requirement.

14. The resource scheduling method of claim 1, wherein the resource allocation of the first scheduling further includes a third region scheduled later than the first region and the second region, and the third region is scheduled solely for the non cell-edge UEs, and a time duration of the sum of the first region and the second region is determined, by the centralized scheduler, in response to a fronthaul status.

15. The resource scheduling method of claim 1, wherein the resource allocation of the first scheduling further includes a third region scheduled later than the first region and the second region, and the third region is scheduled solely for the non cell-edge UEs, and a time duration of the sum of the first region and the second region is determined, by the centralized scheduler, in response to a radio channel status.

16. A baseband unit, comprising:
a centralized scheduler configured to:
classify each of a plurality of user equipments (UEs) as a cell-edge UE or a non cell-edge UE;
perform a first scheduling by allocating a first resource for the cell-edge UEs, a second resource for the non cell-edge UE;
wherein a resource allocation of the first scheduling includes a first region and a second region, the first region is scheduled earlier than the second region, a ratio of the first resource to the second resource in the first region is greater than the ratio of the first resource to the second resource in the second region.

17. The baseband unit of claim 16, wherein the centralized scheduler classifies each UE as the cell-edge UE or the non cell-edge UE in response to a fronthaul status of an RRH to which the UE is connected.

18. The baseband unit of claim 16, wherein the centralized scheduler classifies each UE as the cell-edge UE or the non cell-edge UE in response to an overall network performance.

19. The baseband unit of claim 16, wherein the centralized scheduler classifies the UE periodically, and a period of classifying the UEs is the same as a scheduling period of the first scheduling.

20. The baseband unit of claim 16, wherein the centralized scheduler is further configured to:
determine a time duration of the first region in response to a Quality of Service requirement.

21. The baseband unit of claim 16, wherein the centralized scheduler further configured to:
determine a time duration of the first region in response to a fronthaul status.

22. The baseband unit of claim 16, wherein the centralized scheduler further configured to:
determine a time duration of the first region in response to a radio channel status.

23. The baseband unit of claim 16, wherein the centralized scheduler is further configured to:
determine the ratio of the first resource to the second resource in response to a Quality of Service requirement.

24. The baseband unit of claim 16, wherein the centralized scheduler is further configured to:
determine the ratio of the first resource to the second resource in response to a fronthaul status.

25. The baseband unit of claim 16, wherein the centralized scheduler is further configured to:
determine the ratio of the first resource to the second resource in response to a radio channel status.

26. The baseband unit of claim 16, wherein the resource allocation of the first scheduling further includes a third region scheduled later than the first region and the second region, and the third region is scheduled solely for the non cell-edge UEs, and the centralized scheduler is further configured to:
determine a time duration of the sum of the first region and the second region in response to a Quality of Service requirement.

27. The baseband unit of claim 16, wherein the resource allocation of the first scheduling further includes a third region scheduled later than the first region and the second region, and the third region is scheduled solely for the non cell-edge UEs, and the centralized scheduler is further configured to:
determine a time duration of the sum of the first region and the second region in response to a fronthaul status.

28. The baseband unit of claim 16, wherein the resource allocation of the first scheduling further includes a third region scheduled later than the first region and the second region, and the third region is scheduled solely for the non cell-edge UEs, and the centralized scheduler is further configured to:
determine a time duration of the sum of the first region and the second region in response to a radio channel status.
